(19) United States
(12) Patent Application Publication
(10) Pub. No.: US 2008/0288952 A1
(43) Pub. Date: Nov. 20, 2008

(54) PROCESSING APPARATUS AND DEVICE CONTROL UNIT

(76) Inventors: Takahito SEKI, Tokyo (JP); Kenji Kondo, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/121,850

(22) Filed: May 16, 2008

(30) Foreign Application Priority Data
May 18, 2007 (JP) P2007-132771

(51) Int. Cl. G06F 9/46

(52) U.S. Cl. 718/105

(57) ABSTRACT

A processing apparatus including a plurality of task-processing devices includes a calculation control unit and a device control unit configured to cause the task-processing devices to perform tasks of at least one kind in parallel in accordance with control performed by the calculation control unit. The device control unit sends a command for starting task processing to each of the task-processing devices in accordance with the task group generated by and sent from the calculation control unit. The task-processing devices each execute a task issued from the device control unit, and when the task is complete, each provide a notification that the task is complete to the device control unit. The device control unit provides, in the case in which all tasks included in the task group are complete, a notification that the task group is complete to the calculation control unit.

### CROSS REFERENCES TO RELATED APPLICATIONS

The present invention contains subject matter related to Japanese Patent Application JP 2007-132771 filed in the Japanese Patent Office on May 18, 2007, the entire contents of which are incorporated herein by reference.

### BACKGROUND OF THE INVENTION

1. Field of the Invention

The present invention relates to a processing apparatus including a plurality of device control units and a device control unit.

2. Description of the Related Art

A processing apparatus which has a plurality of functions and is capable of executing the functions in parallel has been developed.

However, if the functions are managed by using only a single central processing unit (CPU), a response time for dealing with interrupts that frequently occur becomes longer. Thus, it is difficult to manage all the functions effectively at high speed.

A processing apparatus of the related art, which is capable of executing a plurality of functions in parallel, will be briefly described with reference to FIG. 1.

FIG. 1 is a block diagram showing a structural example of a processing apparatus 1000 of the related art, the processing apparatus 1000 being capable of executing a plurality of functions in parallel.

As shown in FIG. 1, the processing apparatus 1000 includes a CPU 1001, an interrupt controller 1002, a plurality of devices 1003-1 through 1003-N (where N is a natural number).

The devices 1003-1 through 1003-N are processing units for executing processing in order to realize a plurality of functions, and to operate in synchronization with each other on the basis of a predetermined rule such as synchronization.

The interrupt controller 1002 manages interrupts sent from the devices, and provides interrupt notifications to the CPU 1001.

The CPU 1001 receives the interrupt notifications provided from the interrupt controller 1002, performs processing for the interrupts sent from the devices, and clears the interrupts.

With respect to the processing apparatus 1000 shown in FIG. 1, an exemplary operation in which processing B is performed in the device 1003-2 after the completion of processing A performed by the device 1003-1 will be described below as a specific example.

1. The CPU 1001 writes the setting for causing execution of the processing A in a register provided in the device 1003-1.

2. The CPU 1001 writes the setting for causing execution of the processing B in a register provided in the device 1003-2.

3. The CPU 1001 writes data for starting the processing A in a register provided in the device 1003-1.

4. The device 1003-1 executes the processing A.

5. The device 1003-1 asserts an interrupt request after the execution of the processing A is complete.

6. The interrupt controller 1002 receives the interrupt request sent from the device 1003-1 and provides, to the CPU 1001, a notification with respect to occurrence of an interrupt.

7. The CPU 1001 determines the cause of the interrupt request, and clears the interrupt request sent from the device 1003-1.

8. The CPU 1001 writes data for starting the processing B in a register provided in the device 1003-2.

9. The device 1003-2 executes the processing B.

10. The device 1003-2 asserts an interrupt request after the execution of the processing B is complete.

11. The interrupt controller 1002 receives the interrupt request sent from the device 1003-2 and provides, to the CPU 1001, a notification with respect to occurrence of an interrupt.

12. The CPU 1001 determines the cause of the interrupt request, and clears the interrupt request sent from the device 1003-2.

13. The CPU 1001 completes the processing.

### SUMMARY OF THE INVENTION

As described above, in the processing apparatus 1000, the device 1003-2 executes the processing B after the processing A is complete in the device 1003-1. That is, at least a few milliseconds are necessary for the CPU 1001 to clear the interrupt request after the interrupt request sent from the device 1003-1 has occurred. Thus, a processing speed of a processing apparatus using an interrupt function, such as the processing apparatus 1000, is slow. Therefore, it is desirable to further improve a processing speed.

It is desirable to provide a processing apparatus and a device control unit capable of operating at a higher speed in the case that parallel processing is performed by a plurality of devices.

A processing apparatus including a plurality of task-processing devices each capable of executing a task of one kind or tasks of two or more kinds according to an embodiment of the present invention includes a calculation control unit and a device control unit configured to cause the task-processing devices to perform tasks of at least one kind in parallel in accordance with control performed by the calculation control unit. The calculation control unit generates a task group for causing the task-processing devices to execute pieces of processing and sends the task group to the device control unit. The device control unit sends a command for starting task processing to each of the task-processing devices in accordance with the task group generated by the calculation control unit. The task-processing devices each execute a task issued from the device control unit, and when the task is complete, each provide a notification that the task is complete to the device control unit. The device control unit provides, on the basis of notifications provided from the task-processing devices in the case in which all tasks included in the task group are complete, a notification that the task group is complete to the calculation control unit.

A device control unit for causing a plurality of task-processing devices to perform tasks of at least one kind in parallel in accordance with control performed by a calculation control unit in a processing apparatus including the task-processing devices capable of executing tasks of at least one kind according to an embodiment of the present invention is as follows. In the device control unit, a task is issued to a corresponding one of the task-processing devices in accordance with a relative order of tasks included in a task group generated by the calculation control unit. In the case in which a notification that a task is complete is provided from one of the task-processing devices in accordance with the relative order included in the task group generated by the calculation control unit, the task subsequent to the task whose notification of completion has been provided is issued to the task-processing device in accordance with the relative order included in the task group. In the case in which a notification that the last task included in the task group is complete is provided from one of the task-processing devices, a notification that the task group is complete is provided to the calculation control unit.

According to the embodiments of the present invention, it is desirable to provide a processing apparatus and a device control unit which operate at high speed when a plurality of devices perform parallel processing.

### BRIEF DESCRIPTION OF THE DRAWINGS

FIG. 1 is a block diagram showing a structural example of a processing apparatus of the related art which is capable of executing a plurality of functions in parallel;

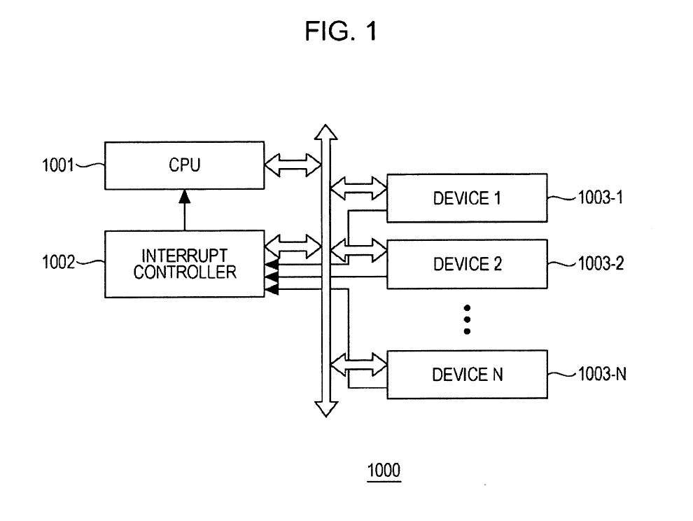

FIG. 2 is a block diagram showing a structural example of a processing apparatus according to a first embodiment of the present invention;

FIG. 3 is a flowchart showing an exemplary operation of the processing apparatus according to the first embodiment of the present invention when tasks are executed;

FIG. 4 is a block diagram used to describe an internal structure of a thread control unit (TCU) according to the first embodiment of the present invention;

FIG. 5 is a flowchart showing an exemplary operation of blocks of the TCU in the case in which the TCU obtains a command for starting a task group from the CPU according to the first embodiment of the present invention;

FIG. 6 is a block diagram showing a processing apparatus according to a second embodiment of the present invention;

FIG. 7 is a time-line chart for when the processing apparatus according to the second embodiment of the present invention is operated;

FIG. 8 is a block diagram showing the structure of a TCU according to the second embodiment of the present invention;

FIG. 9 is a diagram showing an example of arrangement of messages in a task memory according to the second embodiment of the present invention;

FIG. 10 is a diagram showing an exemplary operation for certain processing in a task group; and

FIG. 11 is a block diagram showing an exemplary structure of an image processing apparatus according to a third embodiment of the present invention.

### DESCRIPTION OF THE PREFERRED EMBODIMENTS

Embodiments of a processing apparatus according to the present invention will be described below.

### First Embodiment

A basic structure of a processing apparatus according to a first embodiment of the present invention will be described.

A processing apparatus 100 will be described as an example of the processing apparatus according to the first embodiment of the present invention.

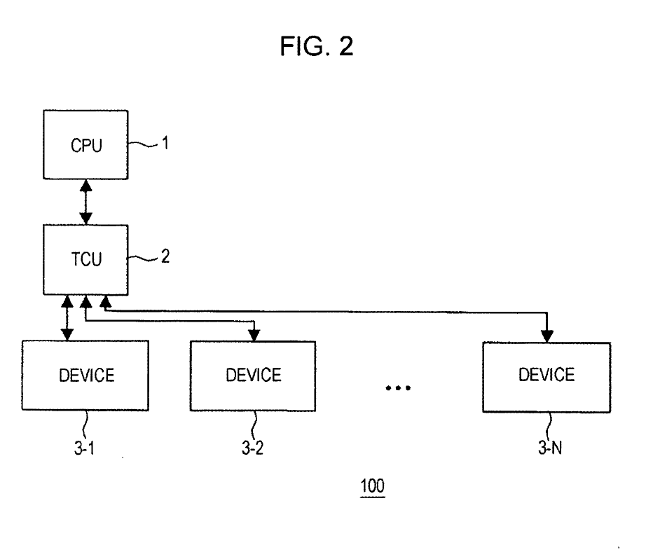

FIG. 2 is a block diagram showing the processing apparatus 100 according to the first embodiment.

As shown in FIG. 2, the processing apparatus 100 includes a CPU 1 (corresponding to a calculation control unit according to an embodiment of the present invention), a TCU 2 (corresponding to a device control unit according to an embodiment of the present invention), and a plurality of devices 3-1 through 3-N (each corresponding to a task-processing device according to an embodiment of the present invention, where N is a natural number).

The CPU 1 is a central processing unit, and executes various calculations.

The CPU 1 sends a command for starting a task group (hereinafter referred to as a “task-group start command”) to the TCU 2 and devices 3-1 through 3-N described below, and causes the TCU 2 and devices 3-1 through 3-N to execute tasks. A task is a unit of processing in the system of the processing apparatus 100, and is processing which the devices 3-1 through 3-N are caused to execute.

The TCU 2 is a processing unit that performs processing between the CPU 1 and the devices 3-1 through 3-N.

The TCU 2 has a function of receiving the task-group start command from the CPU 1 and issuing tasks to the devices 3-1 through 3-N. The TCU 2 allows the devices 3-1 through 3-N to perform parallel processing by managing tasks in the processing apparatus 100.

A detailed structure of the TCU 2 and the like will be described below.

The devices 3-1 through 3-N are processing units for executing various processing of the processing apparatus 100. Although the processing performed by the devices is not specified in the first embodiment of the present invention, such processing units include, for example, a calculation unit, a direct memory access (DMA) processing unit in which DMA is performed, and a stream processing unit in which data transfer is performed between memories or between a memory and a device while data is sorted.

The devices 3-1 through 3-N each execute a task issued by the TCU 2, and each provide a notification indicating that the task execution is complete (hereinafter referred to as a “task-completion notification”) to the TCU 2 when the task is complete.

In the processing apparatus 100 according to the first embodiment, the CPU 1 is positioned at the top of a hierarchized control system. The CPU 1 can perform complex processing; however, its processing speed is slow. The devices 3-1 through 3-N can only perform simple processing; however, their processing speed is fast. The TCU 2 can perform processing with intermediate-complexity and its processing speed is also intermediate compared to the case of the CPU 1 and the case of the devices 3-1 through 3-N. Thus, since the devices 3-1 through 3-N are caused to perform a large amount of processing, and the CPU 1 can manage the performance of the devices 3-1 through 3-N through the TCU 2, high-speed processing is performed in the entirety of the processing apparatus 100.

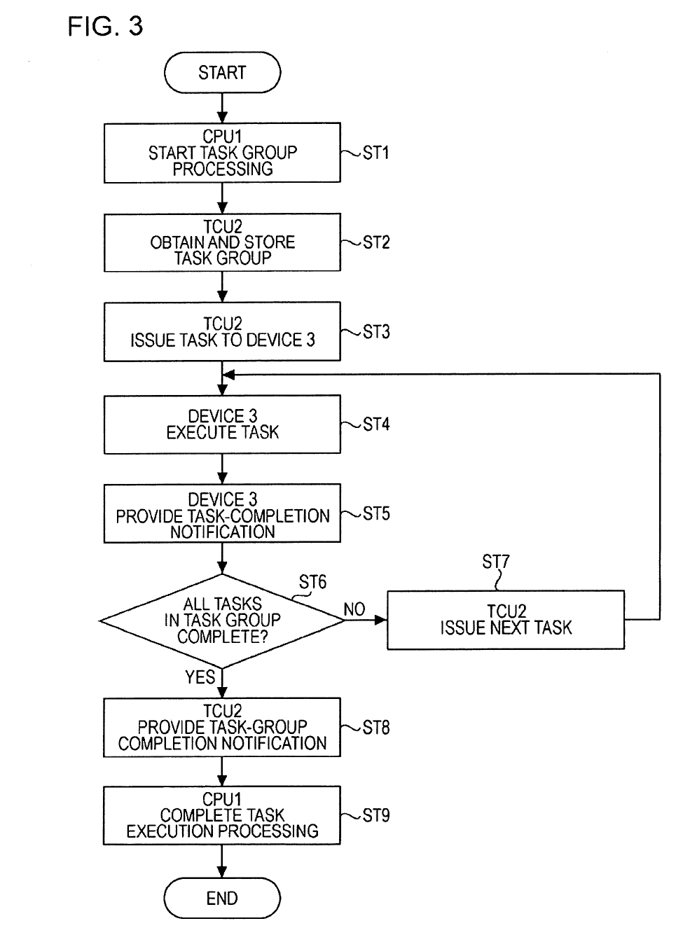

FIG. 3 schematically shows an exemplary operation when tasks are executed in the processing apparatus 100.

FIG. 3 is a flowchart of an exemplary operation when tasks are executed in the processing apparatus 100 according to the first embodiment.

In step ST1, the CPU 1 generates a task group indicating the relative order of tasks that the devices 3-1 through 3-N are caused to perform, and the task group is sent to the TCU 2.

In step ST2, the TCU 2 receives the task group sent from the CPU 1 in step ST1, and stores the task group.

In step ST3, the TCU 2 issues a task to a corresponding one of the devices 3-1 through 3-N so as to satisfy the task group stored in step ST2. That is, the TCU 2 issues a task to a corresponding one of the devices 3-1 through 3-N in accordance with the relative order indicated in the task group.

In step ST4, the device 3 that has received the task issued by the TCU 2 in step ST3 (or step ST7) executes the issued task.

In step ST5, the device 3 provides, to the TCU 2, a notification that the task executed in step ST4 is complete.

In step ST6, the TCU 2 determines whether all the tasks of the task group stored in step ST2 are complete or not on the basis of the task-completion notification provided from the device 3 in step ST5. If the TCU 2 determines that the tasks are not complete, the flow goes to step ST7. Otherwise, the flow goes to step ST8.

In step ST7, the TCU 2 issues an unexecuted task to a corresponding one of the devices 3-1 through 3-N in accordance with the task group, and the flow returns to step ST4.

In step ST 8, the TCU 2 provides, to the CPU 1, a notification that execution of all the tasks of the task group is complete (hereinafter referred to as a “task-group completion notification”).

In step ST9, the CPU 1 completes the task execution processing.

As described with reference to the flowchart shown in FIG. 3, in the processing apparatus 100 according to the first embodiment, the CPU 1 is involved in the task execution processing only at the beginning and end of the task execution processing, and the tasks are executed by the devices 3-1 through 3-N in a distributed manner. Thus, when the tasks are executed by the processing apparatus 100, components thereof (the CPU 1, the TCU 2, and the devices 3-1 through 3-N) are operated in a light-load condition, and the processing speed of the processing apparatus 100 is increased.

After the reception of the task-group completion notification, the CPU 1 may perform a predetermined calculation and generate a new task group on the basis of the calculation result. The CPU 1 may cause the TCU 2 and the devices 3-1 through 3-N to perform new tasks. That is, the CPU 1 can repeatedly generate and execute a task group, and obtain a certain calculation result.

Next, the TCU 2 will be described.

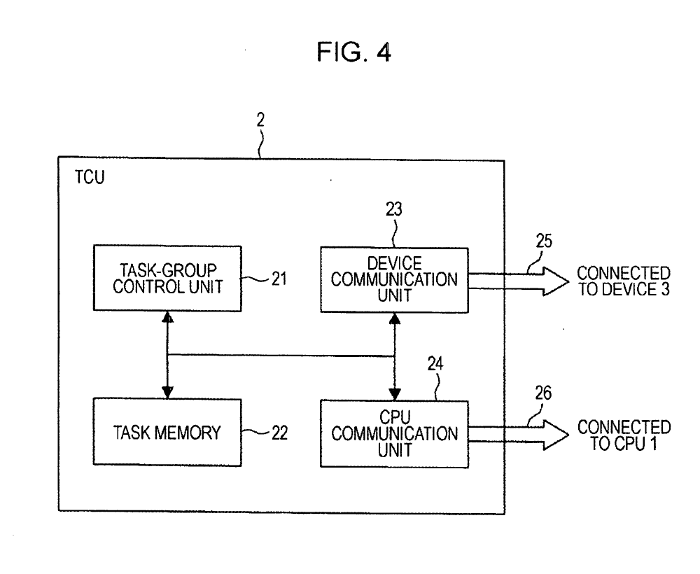

FIG. 4 is a schematic block diagram showing an internal structure of the TCU 2.

As shown in FIG. 4, the TCU 2 includes a task-group control unit 21 (corresponding to a task-group control unit according to an embodiment of the present invention), a task memory 22 (corresponding to a task memory according to an embodiment of the present invention), a device communication unit 23, a CPU communication unit 24, and buses 25 and 26. The TCU 2 is hardware including these components.

The task-group control unit 21 is a control block that obtains the relative order of tasks included in a task group by receiving the task-group start command from the CPU 1 via the CPU communication unit 24 and the bus 26 described below, and causes the devices 3-1 through 3-N to perform corresponding tasks on the basis of the relative order.

The task memory 22 is a memory for storing tasks included in a task group received from the CPU 1.

The device communication unit 23 performs communications with the devices 3-1 through 3-N, sends tasks to corresponding devices 3-1 through 3-N via the bus 25 in accordance with control performed by the task-group control unit 21, and obtains interrupt signals or task-completion notifications provided from the devices 3-1 through 3-N.

The CPU communication unit 24 performs communications with the CPU 1 via the bus 26, obtains a task-group start command, and sends a task-completion notification.

Schematic processing flow performed in the TCU 2 will now be described.

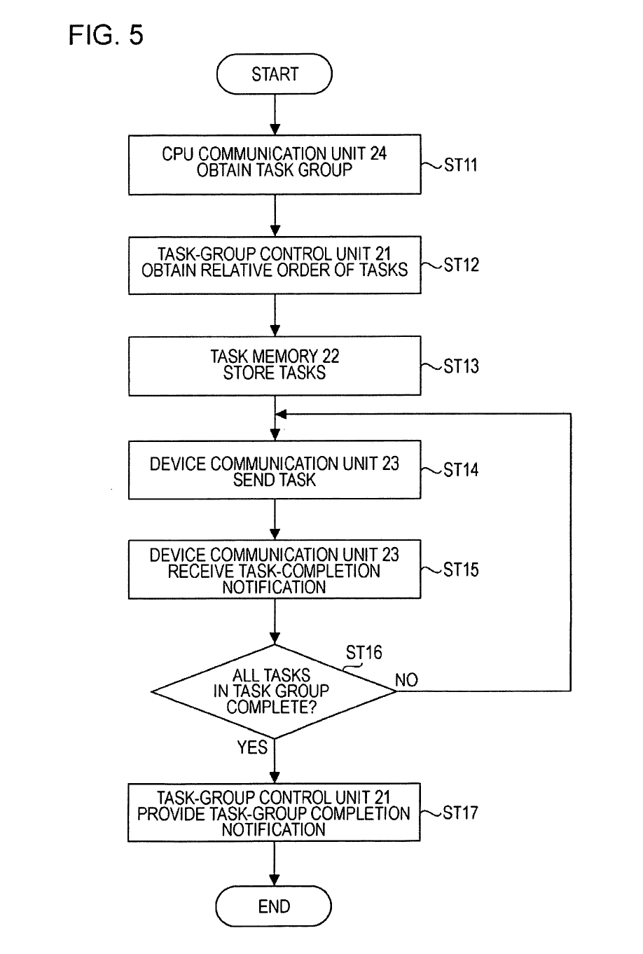

FIG. 5 is a flowchart showing an exemplary operation of the blocks in the TCU 2 when the TCU 2 obtains a task-group start command provided from the CPU 1.

In step ST11, the CPU communication unit 24 obtains a task-group start command from the CPU 1 via the bus 26.

In step ST12, the task-group control unit 21 obtains the relative order of tasks included in the task group on the basis of the task-group start command obtained in step ST11.

In step ST13, the tasks included in the task group are stored in the task memory 22.

In step ST14, the device communication unit 23 sends a task included in the task group obtained in step ST12 to a corresponding one of the devices 3-1 through 3-N via the bus 25 on the basis of the relative order of the tasks in the task group, the relative order being obtained in step ST12, in accordance with control performed by the task-group control unit 21.

In step ST15, the device communication unit 23 receives a task-completion notification indicating that execution of the task sent in step ST14 is complete.

In step ST16, if all the tasks included in the task group and stored in the task memory 22 are complete, the flow goes to step ST17. Otherwise, the flow goes to step ST14.

In step ST17, the task-group control unit 21 sends a task-group completion notification to the CPU 1 via the CPU communication unit 24 and the bus 26.

As described above, according to the processing apparatus 100 of the first embodiment, the TCU 2 causes the devices 3-1 through 3-N to execute the tasks included in the task group according to the relative order in response to the task-group start command issued by the CPU 1, and performs control until all the tasks included in the task group are processed and complete. Thus, when a plurality of tasks are executed, a light load is assigned to the CPU 1. Moreover, the TCU 2 and the devices 3-1 through 3-N handle loads and perform functions in a distributed manner, and thus the processing speed is improved. The TCU 2, which is hardware, causes the devices 3-1 through 3-N to perform the tasks. Thus, the processing speed is improved compared with the case in which, for example, software controls a plurality of devices to perform processing.

### Second Embodiment

A second embodiment relates to a structure for controlling the synchronization between the tasks, described in more detail than in the first embodiment.

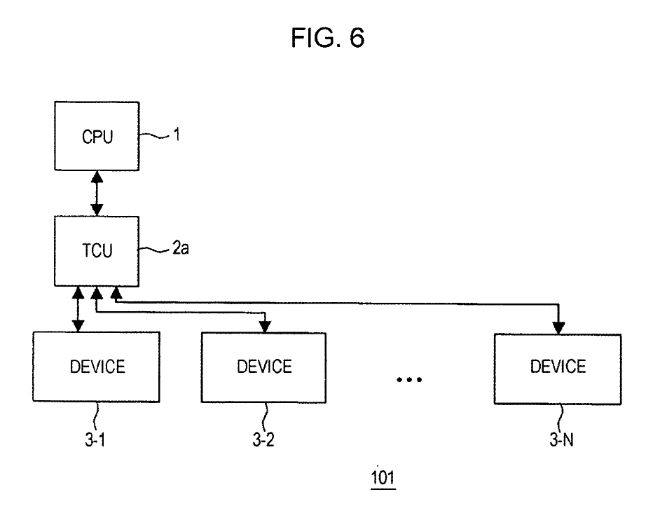

A processing apparatus 101 described in the second embodiment includes the CPU 1, a TCU 2a, and the devices 3-1 through 3-N as shown in FIG. 6.

FIG. 6 is a block diagram showing the processing apparatus 101 according to the second embodiment.

The CPU 1 is a central processing unit, and executes various calculations.

The CPU 1 sends a task-group start command to the TCU 2a and devices 3-1 through 3-N, and causes the TCU 2a and devices 3-1 through 3-N to execute tasks.

The TCU 2a is a processing unit that performs processing between the CPU 1 and the devices 3-1 through 3-N.

The TCU 2a has a function of receiving a task-group start command from the CPU 1 and issuing tasks to the devices 3-1 through 3-N. The TCU 2a allows the devices 3-1 through 3-N to perform parallel processing by managing tasks in the processing apparatus 101.

Moreover, when the TCU 2a issues tasks to a plurality of devices among the devices 3-1 through 3-N and causes the plurality of devices to execute the tasks in parallel, the TCU 2a can synchronize processing between the plurality of devices.

A detailed structure of the TCU 2a and the like will be described below.

The devices 3-1 through 3-N are processing units for executing various processing of the processing apparatus 101. Although the processing performed by the devices 3-1 through 3-N is not specified in the second embodiment of the present invention, the processing units include, for example, a calculation unit, a direct memory access (DMA) processing unit in which DMA is performed, and a stream processing unit in which data transmission is performed between memories or between a memory and a device while data is sorted.

The devices 3-1 through 3-N each execute a task issued by the TCU 2a and each provide a task-completion notification to the TCU 2a when the task is complete.

An exemplary time-series operation of the processing apparatus 101 according to the second embodiment will be described below.

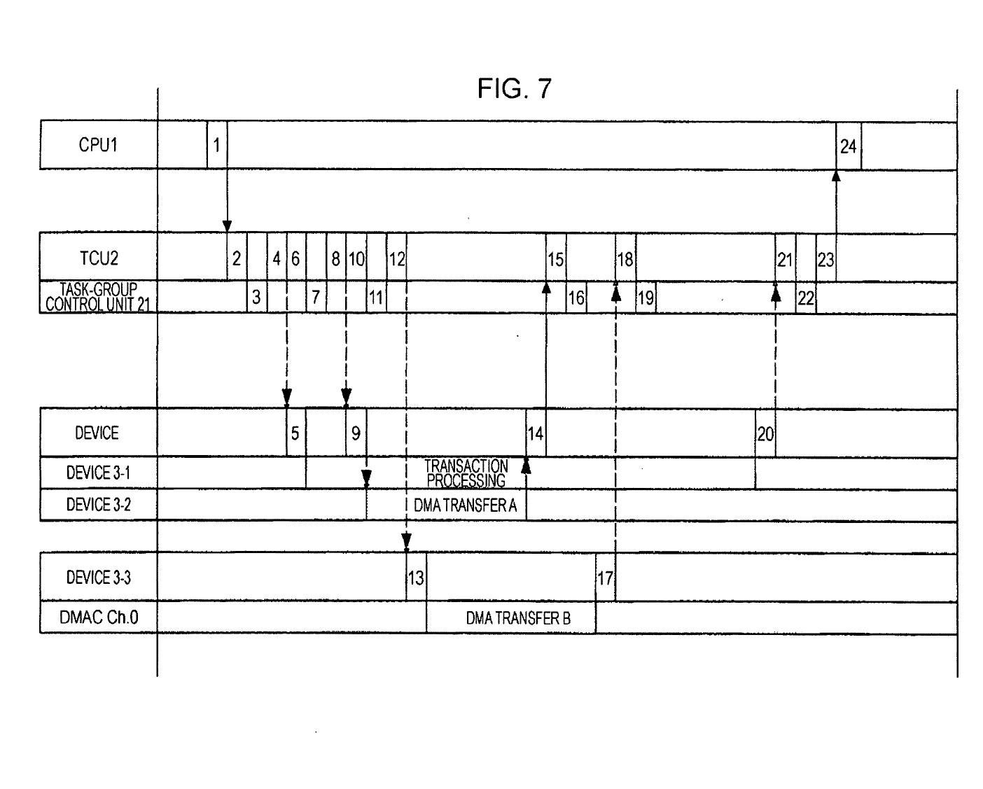

FIG. 7 is a time-line chart for when the processing apparatus 101 according to the second embodiment is operated.

More specifically, the case shown in FIG. 7 in which the processing apparatus 101 includes the devices 3-1 through 3-3 will be described.

Here, for example, the device 3-1 is a calculation unit, and executes transaction processing (a processing method of managing pieces of processing that relate to each other by treating the pieces of processing as processing units), and the devices 3-2 and 3-3 are the DMA processing units that perform DMA transfer processing. DMA is a method of sending and receiving data directly between memories without placing a burden on the CPU 1.

The relative order of the tasks included in the task group that is the subject of the task-group start command supplied from the CPU 1 is transaction execution processing, DMA transfer processing A (performed by the device 3-2), and DMA transfer processing B (performed by the device 3-3).

Time progresses from the left to the right in FIG. 7. Numbered blocks each indicate that its corresponding structural element is activated (certain processing is performed). Such numbered blocks are referred to as active states below.

### Start Phase

In active state 1, the CPU 1 sends a task-group start command to the TCU 2a.

In active state 2, the TCU 2a obtains the relative order of tasks to be executed.

In active state 3, the TCU 2a selects the task (transaction processing) that is the first one to be executed.

### Parallel Operation Phase

In active state 4, the TCU 2a issues the task (transaction processing) to the device 3-1.

In active state 5, the device 3-1 starts execution of the task (transaction processing).

In active state 6, the TCU 2a starts the next task without waiting for the completion of the first task issued to the device 3-1.

In active state 7, the TCU 2a selects the next task (DMA transfer A).

In active state 8, the TCU 2a issues the task (DMA transfer A) to the device 3-2.

In active state 9, the device 3-2 starts up a DMA control (DMAC) function and starts DMA transfer A.

In active state 10, the TCU 2a starts the next task without waiting for the completion of the second task issued to the device 3-2.

In active state 11, the TCU 2a selects the last task (DMA transfer B).

In active state 12, the TCU 2a issues the task (DMA transfer B) to the device 3-3.

In active state 13, the device 3-3 starts up a DMAC function and starts DMA transfer B.

With reference to FIG. 7, it is clear that three devices execute task execution processing in parallel during active states 4 through 13.

### Synchronization Phase

In active state 14, the device 3-2 provides, to the TCU 2a, a notification that the task (DMA transfer A) is complete. This notification is provided as an interrupt signal.

In active state 15, the TCU 2a receives, from the device 3-2, the notification that the task (DMA transfer A) is complete.

In active state 16, the TCU 2a waits until the other devices complete the task execution in order to achieve synchronization.

In active state 17, the device 3-3 provides, to the TCU 2a, a notification that the task (DMA transfer B) is complete. This notification is provided as an interrupt signal.

In active state 18, the TCU 2a receives, from the device 3-3, the notification that the task (DMA transfer B) is complete.

In active state 19, the TCU 2a waits until the device 3-1 completes the task execution in order to achieve synchronization.

In active state 20, the device 3-1 provides, to the TCU 2a, a notification that the task (transaction processing) is complete. This notification is provided as an interrupt signal.

In active state 21, the TCU 2a receives, from the device 3-1, the notification that the task (transaction processing) is complete.

### End Phase

In active state 22, since the TCU 2a has received the notifications that all the three tasks are complete in active state 18, the TCU 2a stops waiting and the last task (processing for performing a task-group completion notification) is selected.

In active state 23, the TCU 2a provides a task-group completion notification to the CPU 1. This notification is provided as an interrupt signal.

In active state 24, the CPU 1 receives the task-group completion notification and completes the task-group execution processing.

As shown in FIG. 7, when the task-group execution processing is performed by the processing apparatus 101 according to the second embodiment, the CPU 1 does not accept any interrupts except for at the beginning and end of the processing (all of active states 2 through 23 are processing for the TCU 2a or the devices 3-1 through 3-3). Thus, a load assigned to the CPU 1 can be lighter.

Moreover, in the processing apparatus 101, when a plurality of devices perform parallel processing, the parallel processing can be synchronized by processing performed by the TCU 2a in active states 16 and 19.

In the following, an example of the structure of the TCU 2a for realizing the above-described processing will be described.

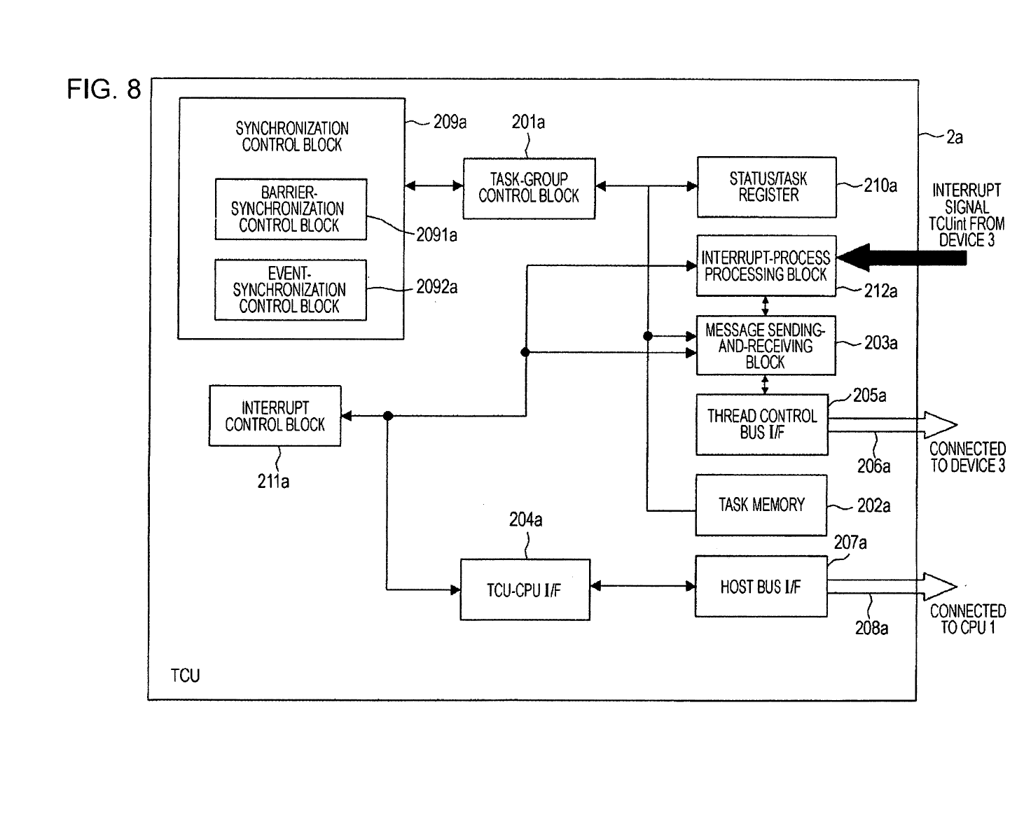

FIG. 8 is a block diagram showing the structure of the TCU 2a.

As shown in FIG. 8, the TCU 2a includes a task-group control block 201a (corresponding to a task-group control unit according to an embodiment of the present invention), a task memory 202a (corresponding to a task memory according to an embodiment of the present invention), a message sending-and-receiving block 203a, a TCU-CPU interface (I/F) 204a, a thread control bus I/F 205a, a bus 206a, a host bus I/F 207a, a bus 208a, a synchronization control block 209a, a status/task register 210a, an interrupt control block 211a, and an interrupt-process processing block 212a.

Here, the task-group control block 201a corresponds to the task-group control unit 21, the task memory 202a corresponds to the task memory 22, the message sending-and-receiving block 203a corresponds to the device communication unit 23, the TCU-CPU I/F 204a corresponds to the CPU communication unit 24, the bus 206a corresponds to the bus 25, and the bus 208a corresponds to the bus 26 in the processing apparatus 100 according to the first embodiment.

The task-group control block 201a is a control block that obtains the relative order of tasks included in a task group by receiving the task-group start command from the CPU 1 via the TCU-CPU I/F 204a and the bus 208a described below, and causes the devices 3-1 through 3-N to perform corresponding tasks according to the relative order.

The task memory 202a is a memory for storing the tasks included in the task group received from the CPU 1.

The message sending-and-receiving block 203a performs communications with the devices 3-1 through 3-N via the thread control bus I/F 205a and the bus 206a. The message sending-and-receiving block 203a sends a message indicating a task to a corresponding device via the bus 206a and receives an interrupt signal or a task-completion notification from the device in accordance with control performed by the task-group control block 201a.

Here, the TCU 2a and the devices 3-1 through 3-N perform communications with messages. Such messages will be specifically described below.

The TCU-CPU I/F 204a performs communications with the CPU 1 via the bus 208a, and stores an execution message used when the CPU 1 controls the TCU 2a and a response message provided from the TCU 2a in response to the execution message. Such messages will be specifically described below.

The thread control bus I/F 205a is used to connect the bus 206a, and helps performing communications with the devices 3-1 through 3-N.

The host bus I/F 207a is used to connect the bus 208a, and helps performing communications with the CPU 1.

The synchronization control block 209a is a block used to control synchronization between task groups, and includes a barrier-synchronization control block 2091a and an event-synchronization control block 2092a.

The barrier-synchronization control block 2091a is a block that controls barrier synchronization between task groups. The event-synchronization control block 2092a is a block that controls event synchronization between task groups.

The barrier-synchronization control block 2091a controls barrier synchronization between devices by causing a device having a barrier identification (ID) to wait until another device having the same barrier ID completes its task.

The event-synchronization control block 2092a controls event synchronization between devices by causing a device having an event ID to wait until another device having the same event ID completes its task.

The status/task register 210a is a register for storing statuses which are parameters indicating states of the devices 3-1 through 3-N, and pointers (task pointers) in the task memory 202a when corresponding tasks allocated by the task-group control block 201a are issued to the devices 3-1 through 3-N. These statuses and task pointers are controlled by the task-group control block 201a.

The interrupt control block 211a and the interrupt-process processing block 212a perform interrupt processing in accordance with an interrupt signal sent to the TCU 2a and a received message in the case in which the devices 3-1 through 3-N send messages to the TCU 2a. An interrupt signal TCUint sent to the TCU 2a from each of the devices 3-1 through 3-N is input to the interrupt-process processing block 212a.

The components of the processing apparatus 101 according to the second embodiment are controlled by messages managed by the task memory 202a. The messages are variable-length data, one packet of which has a length of 32 bits. The messages are classified into internal messages for calling processing of the TCU 2a itself, external messages sent to the devices 3-1 through 3-N, and debug messages. The external messages are classified into “execution messages” for providing instructions to the devices 3-1 through 3-N from the TCU 2a, “response messages” for providing notifications of completion of the instructions to the TCU 2a from the devices 3-1 through 3-N, and “event messages” each of which occurs singly.

Within the TCU 2a, the above-described components call processing by using messages called TCU internal messages. Such TCU internal messages include a task “sync_task” for achieving synchronization and a task “op_task” for performing arithmetic operation.

The task “sync_task” is an internal task for achieving synchronization. For the task “sync_task”, there are five types of messages: fork_task, join_task, joinc_task, barrier_task, and sync_event_task. The five types of messages for the task “sync_task” will be described below.

The fork_task message is a message for initiating fork processing, and causes a certain device to fork an indicated device. The term “fork a device” refers to performing parallel processing in a plurality of tasks/threads with the device.

The join_task message is a message for initiating join processing, and causes a certain device to wait for an indicated device and synchronize with the indicated device. The join_task message causes the device for which the fork_task message has been generated to perform join processing. The term “join” refers to performing synchronization processing, which is processing for waiting for the completion of processing of a different thread.

The joinc_task message is a message for initiating processing performed in a device to be joined, and is provided to the device to be synchronized with the join_task message.

The barrier_task message is a message for initiating barrier synchronization mainly between task groups, and initiates barrier synchronization for an indicated device.

The sync_event_task message is a message for causing a certain device to wait for an event message sent from an indicated device and thereby achieving event synchronization. The sync_event_task message can be provided to other components except for the device which is an object of waiting and which issues an event message.

The task “op_task” is an internal task for performing arithmetic operation.

By using the above-described messages, the TCU 2a performs processing for causing the devices 3-1 through 3-N to execute tasks in parallel.

Next, an example of a message arrangement in the task memory 202a will be described.

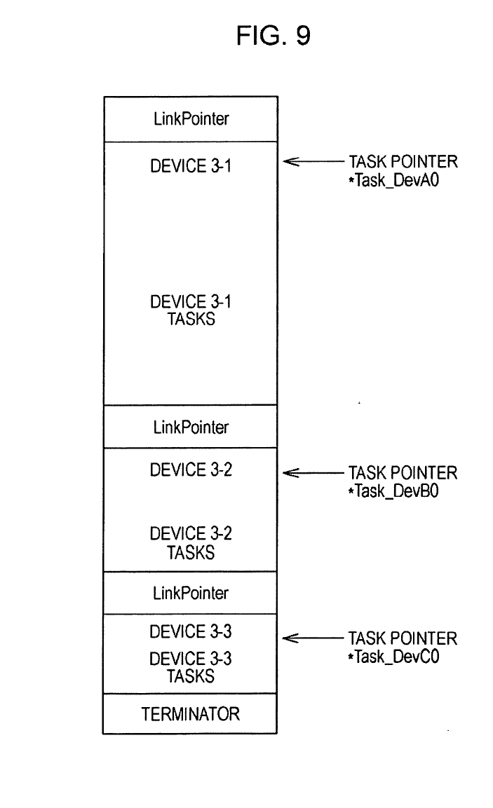

FIG. 9 shows an example of a message arrangement in the task memory 202a. Messages are grouped by device ID DevID allocated to each of the devices, a LinkPointer (which indicates the starting point of a link) is provided at the top of each DevID message group and all the DevID message groups and LinkPointers are combined to form a task group.

As shown in FIG. 9, such a LinkPointer is provided between message groups of different DevIDs and serves as a break point and also as a starting point of the next DevID message group.

In the following, task execution processing in the TCU 2a will be described.

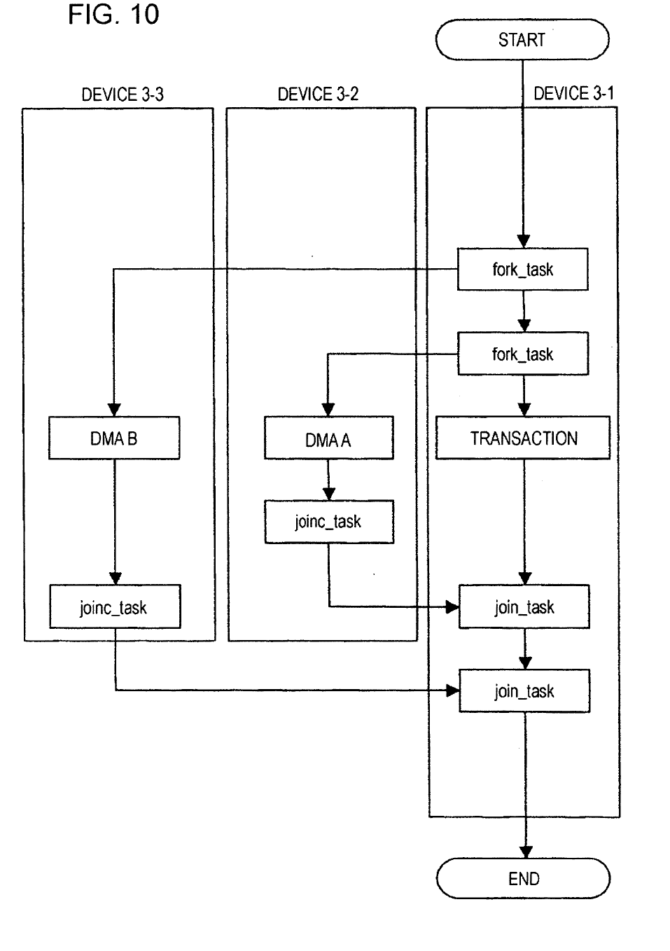

FIG. 10 shows an exemplary operation of processing in a task group.

In the exemplary processing shown in FIG. 10, messages are issued to the three devices 3-1 through 3-3 and waiting processing is initiated by a join_task message. It is assumed that the device 3-1 performs transaction processing, the device 3-2 performs DMA transfer A, and the device 3-3 performs DMA transfer B.

A task pointer (for example, *Task_DevA0 shown in FIG. 9) indicating the position of a sending-target message is provided for each of the devices. While the status (an operation state) of each of the devices is checked, an execution message stored at the position indicated by the task pointer is sent to a device whose previous operation is complete and which is not in a waiting state, and the next processing for the device is started. After the execution message is sent, the task pointer is incremented by an amount corresponding to the length of the sent execution message.

A device that is controlled by the message positioned just after the first LinkPointer of a task group in the task memory 202a is treated as a parent device. The parent device is placed in an operation state just after the task group is started. In the exemplary operation shown in FIG. 10, the parent device is the device 3-1. Devices except for the parent device (the devices 3-2 and 3-3 in the example shown in FIG. 10) among the devices arranged in the same task group are treated as child devices. The fork_task message sent from the parent device enables the child devices to send and receive messages.

Synchronization of devices is achieved by using the join_task message. The joinc_task message is set in the device that causes another device to wait. The join_task message is used to determine whether a task which causes the parent device to wait is complete or not by using device ID DevID.

It is necessary for the parent device to join all the devices that are forked by using the fork_task message. When a terminator is reached in the state in which all the devices are joined, the task group is complete.

In this way, the TCU 2a can cause the devices 3-1 through 3-N (the devices 3-1 through 3-3 in the above-described example) to execute tasks and achieve synchronization between the devices.

As described above, in the processing apparatus 101 according to the second embodiment, the TCU 2a causes devices to execute corresponding tasks included in the task group in accordance with the relative order in response to the task-group start command issued by the CPU 1, and performs control processing of all the tasks included in the task group until the processing is complete. Thus, when a plurality of tasks are executed, a light load is assigned to the CPU 1. Moreover, since the TCU 2 and the devices 3-1 through 3-N handle loads and perform functions in a distributed manner, the processing speed is improved.

Synchronization between the devices 3-1 through 3-N is achieved by using the fork_task message, the join_task message, and the sync_event_task message.

Synchronization between task groups is achieved by using the barrier_task message.

### Third Embodiment

In a third embodiment, an image processing apparatus 300 will be described as an actual example of the processing apparatus.

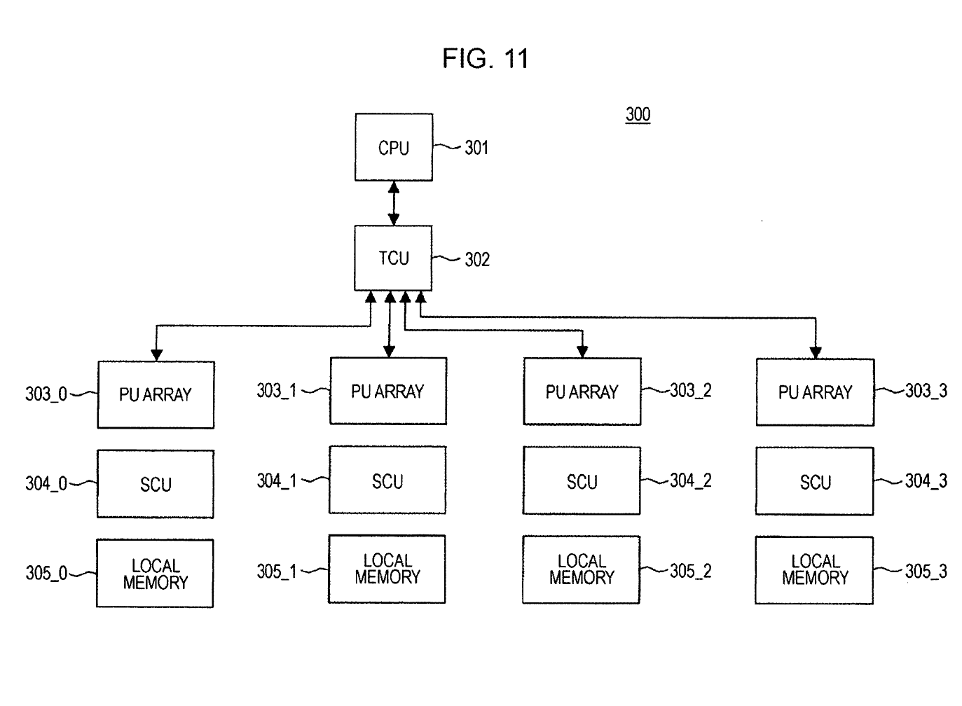

FIG. 11 is a block diagram showing an example of the structure of the image processing apparatus 300 according to the third embodiment.

As shown in FIG. 11, the image processing apparatus 300 includes a CPU 301 (corresponding to a control unit according to an embodiment of the present invention), a TCU 302 (corresponding to a thread control unit according to an embodiment of the present invention), processor-unit (PU) arrays 303_0 through 303_3, stream control units (SCUs) 304_0 through 304_3, and local memories 305_0 through 305_3. The PU arrays 303_0 through 303_3 and the SCUs 304_0 through 304_3 correspond to devices according to an embodiment of the present invention.

In the image processing apparatus 300, processor elements (PEs) in the PU arrays 303_0 through 303_3 and the SCUs 304_0 through 304_3 are run in different threads.

The CPU 301 is a processor that controls the entirety of the image processing apparatus 300.

The TCU 302 is a processing unit that is structurally similar to the TCU 2 in the first embodiment or the TCU 2a in the second embodiment. The TCU 302 performs parallel processing and synchronization processing of the PU arrays 303_0 through 303_3 and SCUs 304_0 through 304_3, similar to the case of the devices 3-1 through 3-N in the first and second embodiments.

The structure and operation of the TCU 302 are similar to those of the TCU 2 in the first embodiment or those of the TCU 2a in the second embodiment; therefore, such a description of the TCU 302 is omitted in the third embodiment.

The PU arrays 303_0 through 303_3 are programmable calculation units and include a plurality of single-instruction multiple data (SIMD)-type processors PU_SIMD.

The SCUs 304_0 through 304_3 control data input/output in the case of reading certain data that is necessary for the PU arrays 303_0 through 303_3 from the memory or in the case of writing processing results of the PU arrays 303_0 through 303_3 into the memory.

The local memories 305_0 through 305_3 are working memories of the image processing apparatus 300. The local memories 305_0 through 305_3 are working memories for storing a part of image data, storing intermediate results supplied as a result of processing performed by the PU arrays 303_0 through 303_3, programs executed by the PU arrays 303_0 through 303_3, and various parameters.

In the image processing apparatus 300, the TCU 302 controls the PU arrays 303_0 through 303_3 so as to be run in a common thread.

Here, “common thread” refers to, for example, processing that progresses on the basis of a common program. The TCU 302 runs the SCUs 304_0 through 304_3 in a thread different from the one in which the PU arrays 303_0 through 303_3 are run.

The PU arrays 303_0 through 303_3 each include a plurality of PEs, and each of the PEs can perform processing on an image section which is one of predetermined-size sections obtained by dividing an image input to the image processing apparatus 300.

In the following, an example of an entire operation of the image processing apparatus 300 will be briefly described.

The CPU 301 sends, to the TCU 302, a command for performing various processing for a predetermined image processing.

The TCU 302 causes the SCUs 304_0 through 304_3 and PU arrays 303_0 through 303_3 to perform image processing.

The SCUs 304_0 through 304_3, respectively, access the local memories 305_0 through 305_3 in accordance with the progress of processing performed by the PEs provided in the PU arrays 303_0 through 303_3, or the SCUs 304_0 through 304_3 access an external memory on the basis of an instruction sent from the TCU 302.

The PEs in the PU arrays 303_0 through 303_3 are run in a thread different from the one for the SCUs 304_0 through 304_3 in accordance with control of the SCUs 304_0 through 304_3 or TCU 302 while utilizing memory-access results of the SCUs 304_0 through 304_3.

In the PU arrays 303_0 through 303_3, SIMD-type processors PU_SIMD #0 through #3 are connected selectively in parallel or in series and operated by the SCUs 304_0 through 304_3.

In the SIMD-type processors PU_SIMD #0 through #3, for example, sixteen PEs 0 through 15 are serially connected, and input or output of pixel data is performed between adjacent PEs as necessary.

As described above, in the image processing apparatus 300, when image processing is performed, parallel processing is performed by the PU arrays 303_0 through 303_3 and SCUs 304_0 through 304_3.

Note that, in the third embodiment, the number of the PU arrays 303_0 through 303_3 is four and the number of the SCUs 304_0 through 304_{—3} is four, and the TCU 302 simultaneously operates four threads; however, it is not necessary that the number of the PU arrays 303_0 through 303_3 is four and the number of the SCUs 304_0 through 304_3 is four on every occasion. The number of such PU arrays or SCUs may be more than four or less than four.

It should be understood by those skilled in the art that various modifications, combinations, sub-combinations and alterations may occur depending on design requirements and other factors insofar as they are within the scope of the appended claims or the equivalents thereof.

What is claimed is:

1. A processing apparatus including a plurality of task-processing devices each capable of executing a task of one kind or tasks of two or more kinds, comprising:
a calculation control unit; and
a device control unit configured to cause the task-processing devices to perform tasks of at least one kind in parallel in accordance with control performed by the calculation control unit,
wherein the calculation control unit generates a task group for causing the task-processing devices to execute pieces of processing and sends the task group to the device control unit,
the device control unit sends a command for starting task processing to each of the task-processing devices in accordance with the task group generated by the calculation control unit,
the task-processing devices each execute a task issued from the device control unit, and when the task is complete, each provide a notification that the task is complete to the device control unit, and
the device control unit provides, on the basis of notifications provided from the task-processing devices in the case in which all tasks included in the task group are complete, a notification that the task group is complete to the calculation control unit.

2. The processing apparatus according to claim 1, wherein the device control unit sends the command for starting the task processing to each of the task-processing devices by using a message, and
the task-processing device provides, to the device control unit, the notification that the task is complete by using an interrupt signal.

3. The processing apparatus according to claim 1, wherein the device control unit issues tasks to the task-processing devices in accordance with a relative order of the tasks included in the task group generated by the calculation control unit.

4. The processing apparatus according to claim 3, wherein, in the case in which a notification that a task is complete is provided from one of the task-processing devices, the device control unit issues, to the task-processing devices, the task subsequent to the task whose notification of completion has been provided in accordance with the relative order included in the task group generated by the calculation control unit.

5. The processing apparatus according to claim 4, wherein the device control unit provides the notification that the task group is complete to the calculation control unit by using an interrupt signal.

6. The processing apparatus according to claim 5, wherein, in the case in which the device control unit causes the task-processing devices to execute tasks of at least one kind, the tasks being included in the task group, the device control unit causes the task-processing devices to be synchronized.

7. The processing apparatus according to claim 6, wherein the device control unit includes:
a task-group control unit configured to obtain the relative order of the tasks included in the task group in accordance with the task group generated by the calculation control unit, and to issue tasks in accordance with the relative order; and
a task memory configured to be used for storing the tasks included in the task group.

8. The processing apparatus according to claim 7, wherein, in the case in which the notification that the task group is complete is provided from the device control unit, the calculation control unit executes a predetermined calculation for the completion of the task group, generates a new task group on the basis of the calculation result after the predetermined calculation is performed, and sends the new task group to the device control unit.

9. A device control unit for causing a plurality of task-processing devices to perform tasks of at least one kind in parallel in accordance with control performed by a calculation control unit in a processing apparatus including the task-processing devices capable of executing tasks of at least one kind, wherein
a task is issued to a corresponding one of the task-processing devices in accordance with a relative order of tasks included in a task group generated by the calculation control unit,
in the case in which a notification that a task is complete is provided from one of the task-processing devices in accordance with the relative order included in the task group generated by the calculation control unit, the task subsequent to the task whose notification of completion has been provided is issued to the task-processing device in accordance with the relative order included in the task group, and
in the case in which a notification that the last task included in the task group is complete is provided from one of the task-processing devices, a notification that the task group is complete is provided to the calculation control unit.

10. The device control unit according to claim 9, wherein synchronization is achieved between the task-processing devices in the case in which the task-processing devices are caused to execute tasks of at least one kind, the tasks being included in the task group.
